(19) United States
(12) Patent Application Publication
(10) Pub. No.: US 2026/0172884 A1
(43) Pub. Date: Jun. 18, 2026

(54) SYSTEM AND METHOD FOR PREVENTING INTERFERENCE DURING TESTING

(71) Applicant: Rohde & Schwarz GmbH & Co. KG, Munich (DE)

(72) Inventor: Nalin GUPTA, Fleet (GB)

(73) Assignee: Rohde & Schwarz GmbH & Co. KG, Munich (DE)

(21) Appl. No.: 18/982,063

(22) Filed: Dec. 16, 2024

(51) Int. Cl. H04W 28/02; H04W 76/27

(52) U.S. Cl. CPC H04W 28/0236; H04W 76/27

(57) ABSTRACT

The present disclosure relates to a method for preventing data plane activity interference in a test system during testing. The test system comprises a first entity and a second entity, wherein one of the entities is a system simulator, and the other entity is a device under test, wherein at least one application exists on one of the entities, the application being configured to generate one or more data requests over a data plane. The method comprises: establishing a connection between the first entity and the second entity; identifying the one or more data requests; and selectively blocking the one or more data requests between the data plane and either a Non-Access Stratum layer or an Access Stratum layer.

### TECHNICAL FIELD

The present disclosure relates to methods and systems for managing data traffic in test environments, specifically for preventing interference from data plane activity that could disrupt testing operations in wireless communication systems. For example, it addresses techniques for controlling or minimizing data interference from the device's data plane during testing of inter-system redirection between 5G and 4G networks.

### BACKGROUND ART

In modern mobile network testing environments, data plane activity from mobile devices often interferes with testing objectives, leading to inaccurate test results or unintended protocol behaviors. This issue is especially pronounced when testing mobile devices that support inter-system redirection between 4G and 5G networks. In such scenarios, certain data activities can inadvertently trigger procedures that disrupt the intended test flow.

For example, when testing inter-system redirection from 5G to 4G, uplink data from a User Equipment (UE) may cause an unintended Service Request in the 5G network, and similarly, downlink data from a System Simulator (SS) may initiate a Paging Procedure in the 5G system. These events are particularly problematic when there is no active radio resource control (RRC) connection, such as during the RRC_idle or RRC_inactive states. In these states, the device is less engaged in active network control, making it vulnerable to unintentional data-triggered events that interfere with test procedures.

Additional issues arise from periodic data activity, such as IPv6 router advertisement messages on the downlink. These messages can disrupt the RRC connection states, introducing interference that complicates testing and affects test accuracy.

This problem is further compounded with modern smartphones, where data activity can originate from multiple sources within the device, including background applications and system processes. These data sources may be difficult to locate and deactivate, leading to persistent data plane activity that disrupts testing. Managing this activity becomes increasingly challenging, especially as devices and networks grow more complex.

### SUMMARY

According to a first aspect, the disclosure relates to a method for preventing data plane activity interference in a test system during testing. The test system comprises a first entity and a second entity, wherein one of the entities is a SS and the other entity is a device under test (DUT). At least one application exists on one of the entities, and the application is configured to generate one or more data requests over a data plane. The method includes: establishing a connection between the first entity and the second entity; identifying the one or more data requests; and selectively blocking the one or more data requests between the data plane and either a Non-Access Stratum (NAS) layer or an Access Stratum (AS) layer.

This achieves the advantage of preventing unintended data plane activity from interfering with testing objectives. By selectively blocking data requests at specific protocol layers (NAS or AS), the method prevents unwanted protocol triggers, such as Service Requests or Paging Procedures, that would otherwise disrupt test scenarios. This approach ensures accurate and reliable testing of protocol and signaling operations.

In an implementation form of the first aspect, the entity on which the application is located is designated as a data-requesting entity, and blocking is performed selectively based on the connection state of this data-requesting entity.

Advantageously, this configuration prevents unintended data plane activity from interfering with testing objectives, particularly in connection states where no active RRC connection is present, such as in the RRC_idle and RRC_inactive states. This selective targeting enhances test accuracy by allowing the dynamic adjustment of the blocking process according to the entity's connection state, thereby preventing unwanted data activity in specific states.

In an implementation form of the first aspect, the one or more data requests are blocked at the AS layer if the data-requesting entity is in an RRC_inactive state.

In an implementation form of the first aspect, the one or more data requests are blocked at the NAS layer if the data-requesting entity is in an RRC_idle state.

This selective targeting based on RRC states ensures that blocking occurs precisely at the most relevant protocol layer, reducing interference during testing.

In an implementation form of the first aspect, the method further includes configuring a blocking parameter to control the selective blocking of the one or more data requests from the data plane; and applying the blocking parameter to ignore one or more data plane indications associated with the one or more data requests according to one or more following modes:
a single-shot mode, where a single data plane indication is ignored;
a multi-shot mode, where a predefined number of data plane indications are ignored;
a persistent mode, where all data plane indications are ignored until the parameter is reset;
a time-based mode, where data plane indications are ignored for a specified period; and
an event-based mode, where data plane indications are ignored until a specific event occurs.

This blocking parameter provides flexible control over data plane activity, allowing the system to adapt the extent and duration of blocking based on testing needs. This flexibility enhances testing accuracy by enabling precise control over data activity and interference according to the selected mode.

In an implementation form of the first aspect, the method further comprises: identifying one or more data requests associated with a predefined network or service; and selectively allowing the one or more data requests associated with the predefined network or service to pass through without blocking, while blocking other data requests based on the connection state of the data-requesting entity.

This selective allowance ensures that predefined signaling traffic, e.g., essential signaling traffic, is not interrupted, preserving key communication flows for accurate protocol testing. For instance, such configuration selectively allows data activity associated with a particular Access Point Name (APN) or Data Network Name (DNN).

In an implementation form of the first aspect, the predefined network or service comprises networks or services associated with IP Multimedia Subsystem (IMS) signaling.

This feature is mainly intended to allow IMS-related signaling data to flow unimpeded, as IMS services are often essential to protocol and signaling tests. Notably, data related to IMS signaling, which is often considered essential for the accurate emulation of real-world network conditions during testing, should not be blocked.

In an implementation form of the first aspect, the first entity is a UE.

In an implementation form of the first aspect, the second entity is a SS.

This configuration supports testing conditions where the UE operates as the DUT and interacts with the SS, simulating real-world network responses.

In an implementation form of the first aspect, the method selectively blocks data requests to prevent interference with ongoing test operations. This targeted blocking enhances test integrity by allowing only non-essential data activity to be blocked, enabling accurate monitoring and control of critical signaling activities.

According to a second aspect, the disclosure relates to a system for preventing data plane activity interference during testing, comprising: a first entity and a second entity, one of which is a SS and the other a DUT, with a connection established between the entities; and at least one application on one of the entities, configured to generate one or more data requests over a data plane. The system is further configured to: identify the one or more data requests; and selectively block the one or more data requests between the data plane and either a NAS layer or an AS layer.

This setup allows the system to prevent interference from specific data plane activity during testing by blocking particular data requests, helping maintain the integrity of test operations.

In an implementation form of the second aspect, the entity on which the application is located is designated as a data-requesting entity, and the system is further configured to selectively block the one or more data requests from the data plane at the NAS layer or the AS layer, based on a connection state of the data-requesting entity.

In an implementation form of the second aspect, the one or more data requests are blocked at the AS layer if the data-requesting entity is in an RRC inactive state.

In an implementation form of the second aspect, the one or more data requests are blocked at the NAS layer if the data-requesting entity is in an RRC idle state.

In an implementation form of the second aspect, the system is configured with a blocking parameter to control the selective blocking of the one or more data requests from the data plane, and the system is configured to apply the blocking parameter to ignore one or more data plane indications associated with the one or more data requests according to one or more following modes:
a single-shot mode, where a single data plane indication is ignored;
a multi-shot mode, where a predefined number of data plane indications are ignored;
a persistent mode, where all data plane indications are ignored until the parameter is reset;
a time-based mode, where data plane indications are ignored for a specified period; and
an event-based mode, where data plane indications are ignored until a specific event occurs.

In an implementation form of the second aspect, the system is further configured to identify one or more data requests associated with a predefined network or service; and selectively allow the one or more data requests associated with the predefined network or service to pass through without blocking, while blocking other data requests based on the connection state of the data-requesting entity.

In an implementation form of the second aspect, the predefined network or service comprises networks or services associated with IMS signaling.

In an implementation form of the second aspect, the first entity is a UE.

In an implementation form of the second aspect, the second entity is the SS.

According to a third aspect, the disclosure relates to a computer program comprising instructions which, when executed by a processor, cause a system to perform the method of the first aspect, or any implementation forms of the first aspect. This enables the invention to be implemented in software, providing flexibility in various test environments.

According to a fourth aspect, the disclosure includes a non-transitory computer-readable medium storing the computer program, which, when executed by a processor, causes a system to perform the method of the first aspect, or any implementation forms of the first aspect. This supports the distribution and deployment of the method across multiple test configurations, enhancing versatility in application.

### BRIEF DESCRIPTION OF THE DRAWINGS

Exemplary embodiments of the disclosure are now further explained with respect to the drawings by way of example only, and not for limitation. In the drawings:

FIG. 1 shows a method according to an embodiment;

FIG. 2 shows a test system according to an embodiment;

FIG. 3 shows a test system according to an embodiment;

FIG. 4 shows a test system according to an embodiment; and

FIG. 5 shows a test system according to an embodiment.

### DETAILED DESCRIPTIONS OF EMBODIMENTS

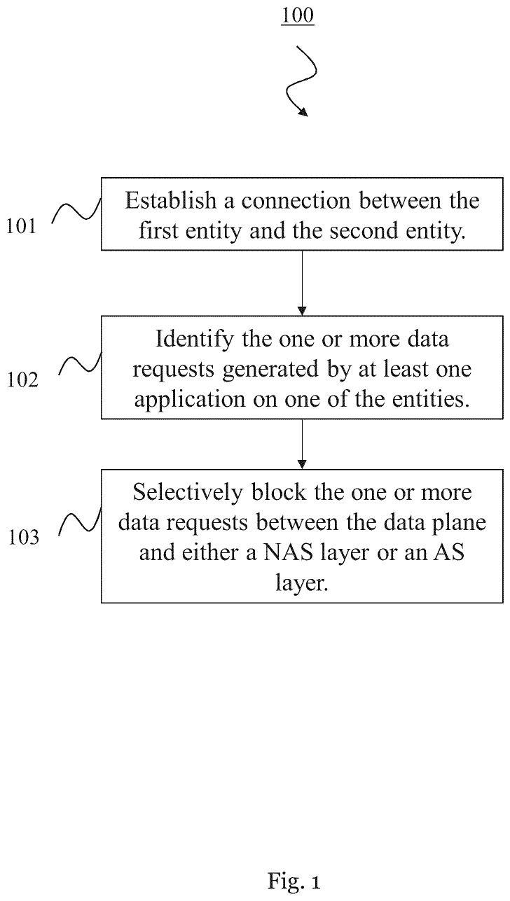

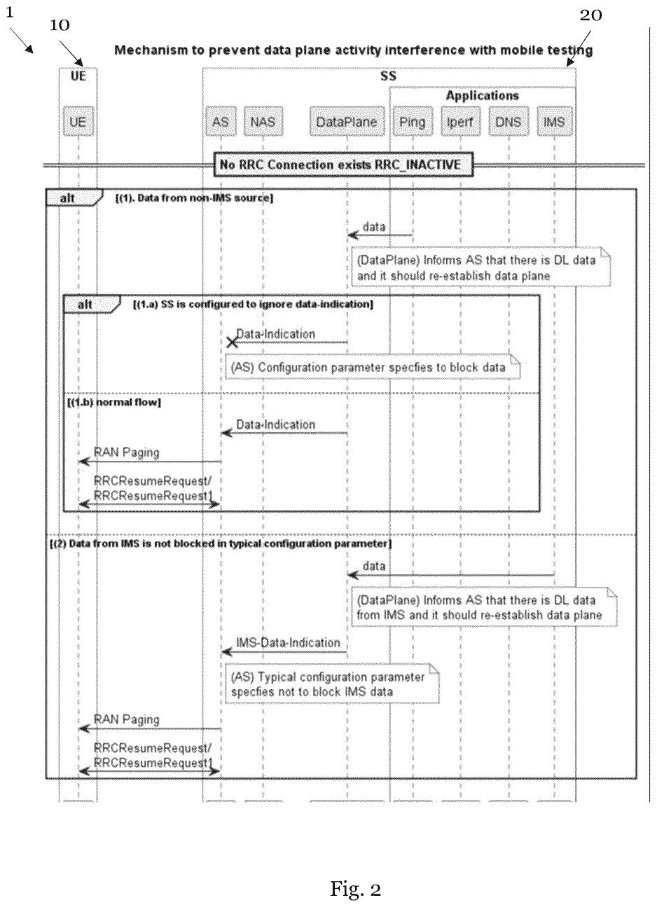

The disclosure provides a method 100 for preventing data plane activity interference during testing. FIG. 1 illustrates an overview of the method, which is implemented within a test system comprising two entities—a SS and a DUT. These entities are connected to facilitate controlled testing processes, typically over a secure and monitored interface that allows for precise control and observation of the data plane activities. FIGS. 2 to 5 provide examples of test system setups that implement this method, showcasing various configurations for different testing scenarios.

The DUT may be a UE, e.g., a mobile device that will be subject to testing. Optionally, the DUT can also be a gNB (next-generation Node B), which is the base station in a 5G network responsible for handling radio communications with the UE. By testing both UE and gNB configurations, the method allows for a comprehensive evaluation of data plane activity in various network scenarios.

As shown in FIG. 1, the method 100 begins by step 101 of establishing a connection between the first entity and the second entity within the test system. This connection allows for controlled data transmission, enabling the DUT or the SS to operate as a data-requesting entity by generating data requests over a data plane.

The method proceeds by step 102 of identifying one or more data requests generated by an application on one of the entities. These data requests can originate from different sources within the DUT or SS, which may include background applications or periodic network communication processes. These data requests are then selectively blocked between the data plane and either a NAS layer or an AS layer, as shown in step 103 of the method in FIG. 1.

The selective blocking at either the NAS or AS layer depends on specific testing requirements and ensures that only targeted data activity is restricted, while critical signaling flows, if necessary, are maintained for accurate testing.

In this testing setup, the applications running on either the SS or the DUT are designed to generate data requests over the data plane, simulating real-world network traffic. These applications are configured to help evaluate data plane interference during testing by emulating typical network activities or specialized testing scenarios. Applications commonly involved include: PING applications, Iperf applications, DNS applications, IMS applications. These applications collectively create a simulated environment that mirrors real-world network conditions. By generating controlled data requests, they allow for precise testing of the DUT's (UE or gNB) ability to manage data plane traffic and prioritize essential data (e.g., IMS) over non-essential data (e.g., bulk data from Iperf) during testing. This helps ensure that the device performs reliably in live network conditions, even with potential interference from ongoing data plane activity.

In this method, the origin of the application generating data activity is irrelevant. By design, this approach addresses the challenge of data plane interference, irrespective of where the data request originates within the device. This is particularly valuable in modern smartphones, where data activity can be initiated by multiple sources, including background applications, system processes, and user applications. It ensures that any data, regardless of its source within the device, can be managed and, if necessary, blocked or allowed based on testing requirements. By isolating and controlling data plane activity, this approach provides a consistent and interference-free environment for testing, even as devices and networks continue to evolve and grow in complexity.

FIGS. 2 to 5 illustrate different signaling scenarios related to data plane activity interference, showing how the method selectively blocks data requests under various conditions. Each of FIGS. 2 to 5 illustrates a test system (referred to as test system 1) configured to prevent data plane activity interference during testing. The test system 1 comprises a first entity 10, which is a DUT, such as a UE, and a second entity 20, which is a SS. The SS and DUT are connected within the test environment, allowing either the SS or DUT to serve as the data-requesting entity under various testing conditions. This setup allows for dynamic handling of data requests based on the data source (IMS or non-IMS) and the connection state (RRC_idle or RRC_inactive), as illustrated in the figures. In these examples, where the DUT is the UE, the SS emulates or manages the network environment, sending commands and data indications to the UE to simulate real-world conditions and observe the UE's response. However, this disclosure also applies to the case where the DUT can be a gNB.

FIG. 2 illustrates a signaling flow in the test system according to an embodiment of this disclosure, demonstrating how the method 100 prevents data plane activity interference when the SS is in the RRC_inactive state. In this scenario, the SS serves as the data-requesting entity, generating data requests that are selectively controlled to prevent interference with testing objectives.

The method 100 may further include a step for identifying and selectively blocking data requests based on the connection state of the data-requesting entity. In FIG. 2, the SS is in the RRC_inactive state. This means that the data plane is not currently active and would need re-establishment if data is to be transmitted. The figure shows two scenarios for handling data requests:

Case (1): Data from a Non-IMS Source

In this scenario, a data request originates from a non-IMS source within the SS, such as background applications or periodic data. The DataPlane layer in the SS identifies this request and generates a Data Indication to the Access Stratum (AS) layer, signaling that there is downlink (DL) data to process. When data arrives from a non-IMS source, the system has options for handling it based on configuration:

Option 1.a: SS is configured to ignore the data indication. The DataPlane layer sends a Data-Indication to the AS informing it of downlink data. The AS layer has a configuration parameter that instructs it to block this data, so no action is taken to re-establish the data plane.

Since the SS is in the RRC_inactive state, the method's selective blocking mechanism applies at the AS layer. In flow (1.a), an AS configuration parameter, or namely, a blocking parameter, is set to block the non-IMS data request in this state, preventing further protocol activity that could interfere with testing. Blocking the data at this stage avoids unintended events, such as re-establishing the data plane or initiating paging procedures. This blocking action ensures that the test environment remains stable, avoiding disruptions from non-essential data. The AS configuration effectively suppresses the data indication in this scenario.

Option 1.b: Normal Flow. If there is no specific configuration to ignore the data, the DataPlane sends a Data-Indication. In this alternative flow (1.b), if the AS is not configured to block, the Data Indication is allowed to proceed, potentially leading to RAN Paging or RRC Resume Requests from the UE, depending on network conditions.

Case (2): Data from an IMS Source

This scenario covers data requests associated with IMS signaling. IMS signaling is critical for emulating real-world network behavior, particularly for services like VoLTE or VoNR.

When IMS data is generated, the DataPlane layer indicates this by sending an IMS Data Indication to the AS layer. Following the method's selective allowance for critical signaling, the AS layer is configured not to block IMS data requests in the RRC_inactive state. This configuration parameter allows IMS data to bypass the blocking mechanism, ensuring that essential IMS-related traffic remains uninterrupted. By permitting IMS signaling data to proceed, the method enables accurate testing of IMS-based services, preserving critical signaling flows and avoiding interference with essential communications.

By designating the SS as the data-requesting entity in the RRC_inactive state and selectively managing data requests based on their type, the method in FIG. 2 prevents unwanted interference while maintaining essential signaling traffic. Non-essential data requests from non-IMS sources are blocked at the AS layer, preventing unintended protocol activations (such as Service Requests or Paging Procedures), whereas IMS data requests are allowed to pass. This selective control maintains the integrity of the test environment, enabling accurate testing of signaling and protocol behaviors without disruption.

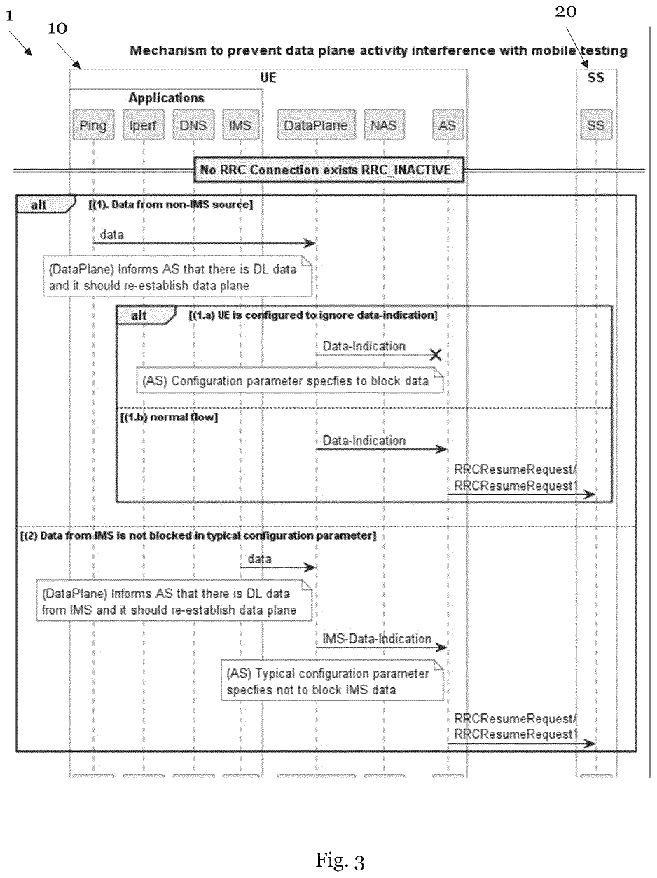

FIG. 3 depicts a scenario in which the DUT, specifically a UE, acts as the data-requesting entity in the RRC_inactive state within test system 1. This figure illustrates how the test system selectively blocks or allows data requests from the UE to prevent interference with testing objectives. In this scenario, the UE serves as the data-requesting entity, generating data requests that are selectively controlled to prevent interference with testing objectives. Similar to FIG. 2, this figure shows two main cases:

Case (1): Data from a Non-IMS Source

The UE generates a data request from a non-IMS source. The DataPlane layer in the UE identifies this request and generates a Data Indication to the Access Stratum (AS) layer, indicating the presence of downlink (DL) data. Since the UE is in the RRC_inactive state, an AS configuration parameter can be set to block non-IMS data requests at this layer (alternative flow 1.a), preventing these data requests from triggering RRC re-establishment or paging procedures that could disrupt testing.

If blocking is not applied (alternative flow 1.b), the Data Indication proceeds, potentially resulting in an RRC Resume Request or Paging procedure, depending on network conditions.

Case (2): Data from an IMS Source

For IMS-related data, the DataPlane layer within the UE sends an IMS Data Indication to the AS layer. The AS layer is configured not to block IMS data requests in this scenario, allowing IMS signaling traffic (such as VoLTE) to proceed unimpeded. This selective allowance maintains critical IMS data flows, ensuring accurate testing of IMS-related protocols.

The embodiment of FIG. 3 demonstrates selective blocking of non-IMS data when the UE is in RRC_inactive, preventing unintended re-establishment of the data plane and thereby maintaining test integrity. Allowing IMS data ensures essential signaling traffic flows for accurate testing of real-world network behaviors.

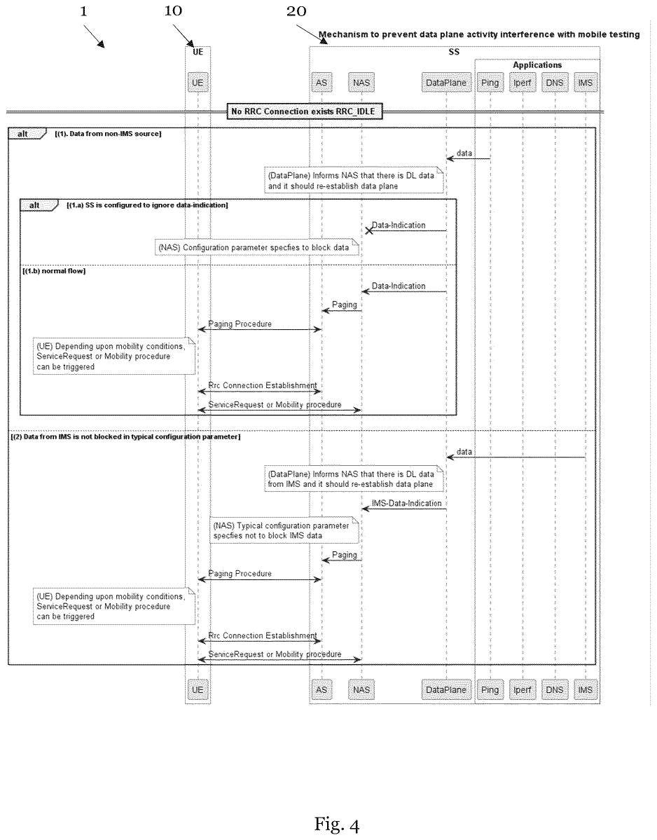

FIG. 4 illustrates a scenario where the SS serves as the data-requesting entity in the RRC_idle state within test system 1. This configuration showcases the selective management of data requests originating from the SS:

Case (1): Data from a Non-IMS Source

A non-IMS data request is generated by the DataPlane layer in the SS, which sends a Data Indication to the NAS layer. In flow 1.a, the SS is configured to ignore the Data Indication. With the SS in the RRC_idle state, the NAS layer is configured to block non-IMS data requests at this level. This prevents non-essential data from triggering paging or mobility procedures that might disrupt the test scenario.

In an alternative flow (normal flow 1.b), if the NAS layer is not configured to block, the Data Indication may proceed, potentially causing a Paging Procedure or triggering a Service Request based on the UE's mobility conditions.

Case (2): Data from an IMS Source

For IMS-related data, the DataPlane layer in the SS sends an IMS Data Indication to the NAS layer. The NAS configuration allows IMS data to bypass the blocking mechanism, ensuring IMS signaling flows continue uninterrupted. This selective handling ensures that IMS-based services can be tested accurately without interference.

The embodiment of FIG. 4 highlights selective blocking at the NAS layer when the SS is in RRC_idle, preventing paging or mobility procedures from being unintentionally triggered by non-IMS data. Allowing IMS data ensures that IMS-related services remain unaffected, providing realistic and accurate testing conditions.

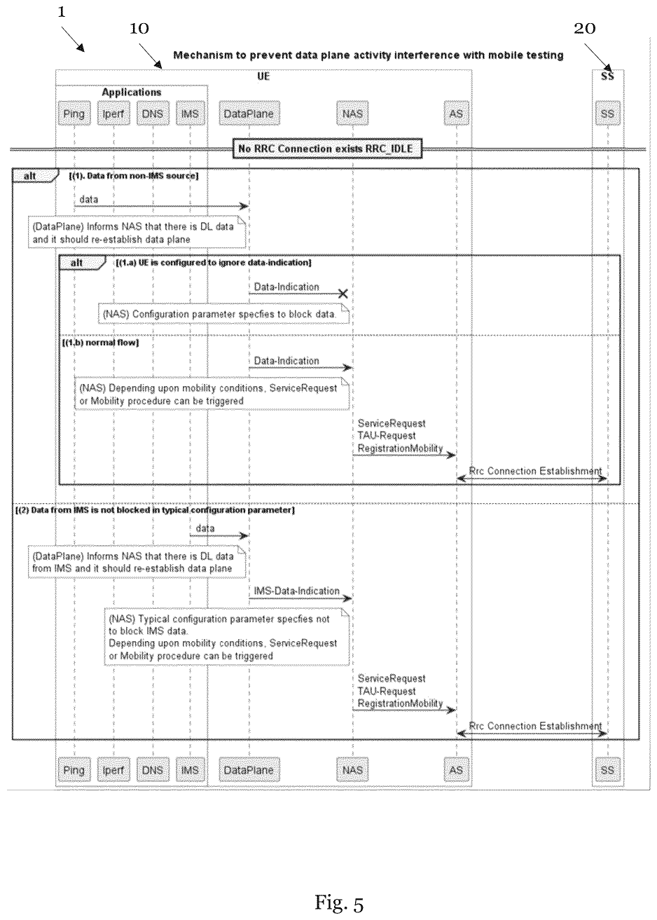

FIG. 5 illustrates a scenario where the DUT (UE) is in the RRC_idle state and acts as the data-requesting entity within test system 1. The test system selectively blocks or allows data requests to manage data plane activity effectively.

Case (1): Data from a Non-IMS Source

The DataPlane layer within the UE detects a non-IMS data request and sends a Data Indication to the NAS layer. In flow 1.a, the UE is configured to ignore the Data Indication. Since the UE is in RRC_idle, the NAS layer is configured to block non-IMS data requests, preventing unintended RRC connection establishment or paging, which could interfere with the test.

If blocking is not configured (alternative flow 1.b), the Data Indication may proceed, potentially triggering a Service Request or Mobility Procedure based on network conditions.

Case (2): Data from an IMS Source

For IMS-related data, the DataPlane layer within the UE generates an IMS Data Indication to the NAS layer. The NAS configuration allows IMS data to proceed without blocking, ensuring that IMS signaling (e.g., VoLTE) flows remain intact for realistic protocol testing.

The embodiment of FIG. 5 illustrates selective blocking of non-IMS data at the NAS layer in the RRC_idle state, preventing unintended protocol events while allowing essential IMS data to proceed. This setup enables accurate testing by maintaining the test environment's stability and ensuring critical IMS signaling is preserved.

In summary, each of FIGS. 2 to 5 demonstrates how test system 1 selectively manages data requests based on the RRC connection state of the data-requesting entity and the nature of the data (IMS vs. non-IMS). Together, these figures illustrate the method's adaptability in selectively blocking non-essential data while allowing IMS signaling to proceed, minimizing interference and ensuring accurate testing of protocol behaviors in realistic conditions.

As discussed in the previous embodiments, to control and manage data plane activity effectively, configuration parameters can be implemented at the NAS or AS protocol levels. These parameters allow selective blocking of data indications sent during RRC_idle and RRC_inactive states. The configuration parameters can be tailored to handle data requests in several ways, enhancing the flexibility and control within the test system.

For instance, the configuration parameter can be designed as cardinality of ignoring indications in one or more of the following manners:
Single-shot mode: Ignores a single data indication.
Multi-shot mode: Ignores a predefined number of data indications.
Persistent mode: Ignores all data indications until the parameter is reset or disabled.
Time-based mode: Ignores data indications for a specified duration.
Event-based mode: Ignores data indications until a specific event occurs.

These modes provide the system with a fine-grained ability to control data plane activity and prevent unnecessary protocol activations that may interfere with testing. For example, the persistent mode can be used to block all non-IMS data throughout the test, while time-based or event-based modes can restrict data for defined periods or until specified conditions are met.

Additionally, the configuration parameters include an option to selectively allow data activity associated with a particular APN or DNN. This feature is mainly intended to allow IMS-related signaling data to flow unimpeded, as IMS services are often essential to protocol and signaling tests. This selective allowance prevents NAS and RRC protocols from triggering procedures (e.g., Paging or Service Requests) based on non-IMS data, ensuring that only IMS signaling traffic is maintained for accurate testing.

The configuration parameters are implemented independently at both the UE (DUT) and SS, providing flexibility for handling data requests originating from either entity based on the specific test scenario. By configuring the parameters for each entity, the test system can adapt to varied network conditions and testing needs, effectively managing data activity interference.

According to another aspect, the disclosure can be implemented as a computer program stored on a non-transitory computer-readable medium. This program comprises instructions which, when executed by a processor, enable a system to perform the steps of the method as described in one of the above described embodiments. Specifically, the computer program would configure and control the test system (including the SS and DUT) to:
Establish a connection between the SS and DUT,
Identify data requests generated over the data plane,
Apply the selective blocking configurations as per the NAS and AS protocol settings, and
Manage the data indications based on the modes (e.g., single-shot, persistent, event-based) and APN/DNN allowances.

This software implementation provides a flexible, programmable solution that can be deployed across various testing environments to prevent data plane interference, making it adaptable for both hardware-based and virtual test configurations.

The present disclosure provides a comprehensive solution for managing data plane activity interference during testing by using configurable parameters at the NAS and AS protocol layers. By selectively blocking non-IMS data requests and allowing IMS-related traffic, the test system (test system 1) maintains the integrity of protocol testing while minimizing unintended triggers from non-essential data activity. The proposed configuration options—such as single-shot, multi-shot, persistent, time-based, and event-based modes—offer flexible control tailored to specific testing requirements, enhancing accuracy and reliability.

The disclosure can be implemented as a computer program or software solution that enables dynamic management of data requests based on connection states and data types. This software-based approach allows for scalable deployment across different testing platforms, including both physical devices and virtualized testing environments. The configurable parameters at the NAS and AS layers, combined with APN/DNN allowances, provide an adaptable framework that can effectively prevent data plane interference, enabling precise control over signaling and protocol behavior for advanced testing scenarios.

In sum, embodiments of this application enhance the reliability of mobile device testing by reducing unintended data plane interference, ensuring that only essential IMS signaling traffic is preserved while non-essential data is blocked as per configurable settings. This selective approach provides a robust solution for testing in multi-network environments and supports accurate emulation of real-world conditions, ultimately contributing to the development and verification of wireless communication protocols.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the present disclosure may have been disclosed with respect to only one of several implementations, such feature may be combined with one or more other features of the other implementations as may be desired and advantageous for any given or particular application.

1. A method for preventing data plane activity interference in a test system during testing, wherein the test system comprises a first entity and a second entity, wherein one of the entities is a system simulator, SS, and the other entity is a device under test, DUT, wherein at least one application exists on one of the entities, the application being configured to generate one or more data requests over a data plane, the method comprising:
establishing a connection between the first entity and the second entity;
identifying the one or more data requests; and
selectively blocking the one or more data requests between the data plane and either a Non-Access Stratum, NAS, layer or an Access Stratum, AS, layer.

2. The method of claim 1,
wherein the entity on which the application is located is designated as a data-requesting entity,
wherein blocking the data request comprises: selectively blocking the one or more data requests from the data plane at the NAS layer or the AS layer, based on a connection state of the data-requesting entity.

3. The method of claim 2,
wherein the one or more data requests are blocked at the AS layer if the data-requesting entity is in a Radio Resource Control, RRC, inactive state.

4. The method of claim 2,
wherein the one or more data requests are blocked at the NAS layer if the data-requesting entity is in an RRC idle state.

5. The method of claim 2, further comprising:
configuring a blocking parameter to control the selective blocking of the one or more data requests from the data plane;
applying the blocking parameter to ignore one or more data plane indications associated with the one or more data requests according to one or more following modes:
a single-shot mode, wherein a single data plane indication is ignored;
a multi-shot mode, wherein a predefined number of data plane indications are ignored;
a persistent mode, wherein all data plane indications are ignored until the blocking parameter is reset;
a time-based mode, wherein data plane indications are ignored for a specified period of time; and
an event-based mode, wherein data plane indications are ignored until a specified event occurs.

6. The method of claim 2, further comprises:
identifying one or more data requests associated with a predefined network or service; and
selectively allowing the one or more data requests associated with the predefined network or service to pass through without blocking, while blocking other data requests based on the connection state of the data-requesting entity.

7. The method of claim 6,
wherein the predefined network or service comprises networks or services associated with IP Multimedia Subsystem, IMS, signaling.

8. The method of claim 1,
wherein the first entity is a user equipment, UE.

9. The method of claim 1,
wherein the second entity is a SS.

10. The method of claim 1,
wherein blocking the one or more data requests prevents interference with ongoing test operations.

11. A system for preventing data plane activity interference during testing, comprising:
a first entity and a second entity, wherein one of the entities is a system simulator, SS, and the other entity is a device under test, DUT, where a connection is established between the first entity and the second entity,
at least one application on one of the entities, the application being configured to generate one or more data requests over a data plane,
wherein the system is configured to:
identify the one or more data requests, and
selectively block the one or more data requests between the data plane and either a Non-Access Stratum, NAS, layer or an Access Stratum, AS, layer.

12. The system of claim 11,
wherein the entity on which the application is located is designated as a data-requesting entity,
wherein system is further configured to selectively block the one or more data requests from the data plane at the NAS layer or the AS layer, based on a connection state of the data-requesting entity.

13. The system of claim 12,
wherein the one or more data requests are blocked at the AS layer if the data-requesting entity is in a Radio Resource Control, RRC, inactive state.

14. The system of claim 12,
wherein the one or more data requests are blocked at the NAS layer if the data-requesting entity is in an RRC idle state.

15. The system of claim 12,
wherein the system is configured with a blocking parameter to control the selective blocking of the one or more data requests from the data plane,
wherein the system is configured to apply the blocking parameter to ignore one or more data plane indications associated with the one or more data requests according to one or more following modes:
a single-shot mode, wherein a single data plane indication is ignored;
a multi-shot mode, wherein a predefined number of data plane indications are ignored;
a persistent mode, wherein all data plane indications are ignored until the blocking parameter is reset;
a time-based mode, wherein data plane indications are ignored for a specified period of time; and
an event-based mode, wherein data plane indications are ignored until a specified event occurs.

16. The system of claim 12,
wherein the system is further configured to:
identify one or more data requests associated with a predefined network or service; and
selectively allow the one or more data requests associated with the predefined network or service to pass through without blocking, while blocking other data requests based on the connection state of the data-requesting entity.

17. The system of claim 16,
wherein the predefined network or service comprises networks or services associated with IP Multimedia Subsystem, IMS, signaling.

18. The system of claim 11,
wherein the first entity is a user equipment, UE.

19. The system of claim 11,
wherein the second entity is the SS.

20. A computer program comprising instructions which, when executed by a processor, cause a system to perform the method of claim 1.

21. A non-transitory computer-readable medium storing a computer program comprising instructions which, when executed by a processor, cause a system to perform the method of claim 1.
